(19) United States
(12) Patent Application Publication
(10) Pub. No.: US 2015/0212191 A1
(43) Pub. Date: Jul. 30, 2015

(54) METHOD AND APPARATUS FOR OPTIMIZING POSITIONING BASED ON POSITIONING COMPATIBILITY CLASSIFICATION

(71) Applicant: Qualcomm Incorporated, San Diego, CA (US)

(72) Inventors: Gengsheng Zhang, Cupertino, CA (US); Ju-Yong Do, Palo Alto, CA (US); Sundar Raman, Fremont, CA (US); Chandrakant Mehta, Santa Clara, CA (US); Arie Rahmat, San Diego, CA (US); Sunil Patel, Santa Clara, CA (US)

(21) Appl. No.: 14/494,483

(22) Filed: Sep. 23, 2014

Related U.S. Application Data
(60) Provisional application No. 61/932,165, filed on Jan. 27, 2014.

(51) Int. Cl. G01S 5/02

(52) U.S. Cl. CPC G01S 5/02

(57) ABSTRACT

Method, device, computer program product, and apparatus for performing and processing mobile device positioning are described. A mobile device can request vertical positioning assistance. The mobile device can receive vertical positioning assistance from a transmitter classified for vertical positioning assistance. The mobile device can receive optimized assistance data created in response to a particular positioning request. The optimized assistance data may be optimized for vertical position, horizontal positioning, or both usage types. The mobile device can receive usage type classifications directly from a transmitter. A server can receive and determine a request is a vertical positioning request. Vertical positioning can include determining one or more of: an altitude, floor, level, or any combination thereof, within the environment. Assistance data associated with a plurality of transmitters, vertical positioning assistance data from a transmitter classified for providing vertical assistance is selected and provided as vertical positioning assistance data.

### CROSS-REFERENCE TO RELATED APPLICATIONS

This application claims the benefit of U.S. Provisional Application No. 61/932,165 filed on Jan. 27, 2014, and expressly incorporated herein by reference.

### FIELD

The subject matter disclosed herein relates generally to positioning optimization with wireless transmitters.

### BACKGROUND

Electronic devices may include a variety of sensors and inputs to monitor and infer relative device position. For example, based on input received by a WiFi sensor, a device can measure Received Signal Strength Indication (RSSI) or Round Trip Time (RTT) to infer device position relative to one or more wireless transmitters.

Indoor positioning systems can send and receive maps containing the physical layout of a building or floor as well as information about the location of known wireless transmitters. For example, a map may include wall and window information for a venue, as well as RSSI and RTT heatmaps for wireless transmitter locations. Therefore, when a mobile device connects to a venue, some or all of the map information may be used to determine position of the mobile device. However, some open areas and buildings may have wireless transmitters that are detectable (e.g., hearable, or discoverable) within more than one floor.

Devices that are detectable across multiple floors typically produce positioning errors for devices trying to ascertain vertical/floor positioning in an environment. For example, a wireless transmitter may broadcast from a ceiling of an open multi-level shopping center, or may bounce signals down an open stairwell such that a mobile device may be misled as to the actual floor location of the wireless transmitter. Therefore, improved positioning techniques for locations with a variety of wireless transmitters is needed.

### SUMMARY

Embodiments disclosed herein may relate to a method for performing mobile device positioning. The method may include receiving, at a mobile device, a positioning compatibility classification of a first transmitter and determining, according to the positioning compatibility classification, the first transmitter is compatible with vertical positioning assistance. The method may also include receiving a vertical position of the first transmitter and measuring a first radio frequency (RF) signal from the first transmitter. The method may also include determining a vertical position of the mobile device based on the first measured RF signal and the first transmitter's vertical position.

Embodiments disclosed herein may relate to a mobile device for performing mobile device positioning. The device may include instructions to receive, at a mobile device, a positioning compatibility classification of a first transmitter and determine, according to the positioning compatibility classification, the first transmitter is compatible with vertical positioning assistance. The device may also include instructions to receive a vertical position of the first transmitter and measure a first RF signal from the first transmitter. The device may also include instructions to determine a vertical position of the mobile device based on the first measured RF signal and the first transmitter's vertical position.

Embodiments disclosed herein may relate to a method for performing mobile device positioning at a server. The method may include receiving, at the server, a first positioning request and determining the first positioning request comprises a vertical positioning request. The method may also include selecting, from assistance data associated with a plurality of transmitters, vertical positioning assistance data associated with one or more transmitters classified for providing vertical assistance, where the vertical positioning assistance data comprises data associated with transmitters compatible with vertical positioning assistance while excluding assistance data associated with transmitters compatible only with horizontal positioning assistance. The method may further include providing the selected vertical positioning assistance data.

Embodiments disclosed herein may relate to a server for performing mobile device positioning. The server may include instructions to receive a first positioning request and determine the first positioning request comprises a vertical positioning request. The server may also include instructions to select, from assistance data associated with a plurality of transmitters, vertical positioning assistance data associated with one or more transmitters classified for providing vertical assistance, where the vertical positioning assistance data comprises data associated with transmitters compatible with vertical positioning assistance while excluding assistance data associated with transmitters compatible only with horizontal positioning assistance. The server may further include instructions to provide the selected vertical positioning assistance data.

Other features and advantages will be apparent from the accompanying drawings and from the detailed description.

### BRIEF DESCRIPTION OF THE DRAWINGS

FIG. 1 is a diagram of an exemplary operating environment for positioning a mobile device;

FIG. 2 is a flow diagram illustrating a method for a server to provide positioning assistance, in one embodiment;

FIG. 3 is a flow diagram illustrating a method for a server to provide vertical positioning assistance data, in one embodiment;

FIG. 4 is a flow diagram illustrating a method for a mobile device to perform vertical positioning, in one embodiment;

FIG. 5 is graph illustrating example probability results for determining vertical positioning, in one embodiment; and

FIG. 6 is block diagram illustrating a device to perform mobile positioning, in one embodiment.

### DESCRIPTION

In one embodiment, a mobile device and server leverage a set of transmitters (described herein simply as “transmitters”) optimized to provide vertical and/or horizontal positioning assistance in an environment. Vertical positioning, as used herein, describes the process of locating a device's floor, level, or altitude range, within an indoor environment. For example, a mobile device may use vertical positioning to determine the mobile device is currently on the particular (e.g., first, second, third, etc.) floor of a building or structure. Horizontal positioning, as used herein, describes the process of locating a device's position within a particular or same floor, level, or altitude range equivalent to a floor or level of an indoor environment. For example, horizontal positioning may be used to determine a position within a particular vertical position in a location.

In one embodiment, in response to reading or detecting the classification of nearby transmitters, a mobile device targets transmitter signals relevant to a particular type of positioning while ignoring transmitter signals from potentially problematic or misleading transmitters. Therefore, the speed and accuracy of positioning determination by the mobile device may be greatly enhanced through the implementation of vertical and horizontally optimized positioning assistance. In another embodiment, a server provides mobile devices with vertical and/or horizontal positioning assistance data optimized for efficient data transfer in a wireless network.

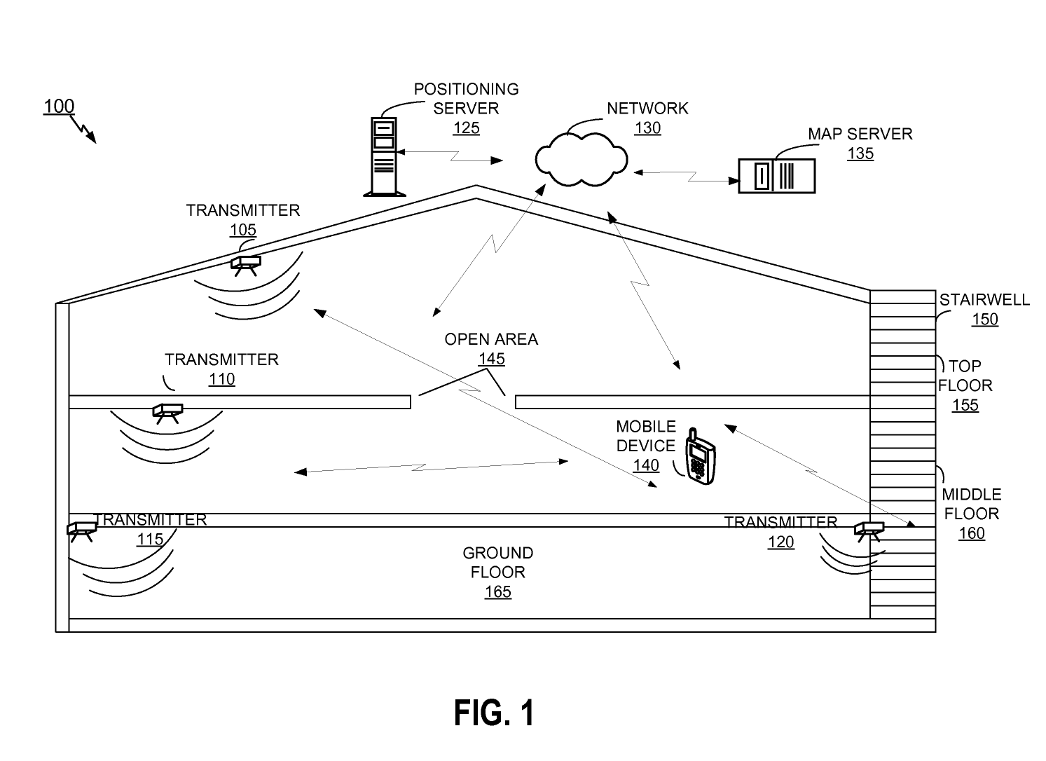

FIG. 1 is a diagram of an exemplary operating environment for positioning a mobile device. In one embodiment, the operating environment includes a location (e.g., location 100) where mobile device (e.g., mobile device 140), one or more transmitters (e.g., transmitters 105-120), and servers (e.g., positioning server 125 and map server 135), perform the embodiments described herein. Location 100 may be an indoor location such as a venue, shopping mall, office space, or other location having multiple floors or levels (e.g., floors 155-165). In some embodiments, location 100 may be a combination of indoor and outdoor structures such as an outdoor section and an indoor section (e.g., a mall that has indoor and outdoor sections). Each floor or level within location 100 may have one or more transmitters used for providing data connectivity and/or positioning assistance to devices.

In one embodiment, a map server (e.g., map server 135 or optionally positioning server 125) provides a map from a database or archive to mobile device 140. The map may be implemented as a CAD file or xml file and may contain details regarding physical structure or landmarks (e.g., designating pedestrian accessible areas or paths) of the location. The map may also include locations of transmitters in a venue according. The map may be maintained by a venue (e.g., location 100) and updated with changes to the transmitter layout within location 100.

In one embodiment, mobile device 140 performs indoor positioning through analysis of signals from one or more transmitters (e.g., 105-120). In one embodiment, transmitters 105-120 are Wi-Fi access points, Bluetooth devices, radio frequency (RF) transmitters, or other wireless transmission types and are configured to provide mobile device positioning within location 100. Transmitters 105-120 may be APs that are part of a Wireless Network 130 (e.g., Wireless Local Area Network, Wide Area Network, etc.), which may operate in buildings and perform communications over a relatively small geographic region compared to a Cellular or Wide Area Network. Such APs may be part of, for example, Wi-Fi networks (802.11n, 802.11ac, 802.11ax, etc.).

One or more transmitters 105-120 may have wireless signals that extend beyond their respective floor or level (e.g., top floor 155, middle floor 160, or ground floor 165 respectively). For example, transmitter 105 installed on the top floor 155 sends signals that extend through an open area 145 to reach the middle floor 160. Transmitter 120 installed on the ground floor 165 sends signals that extend through stairwell 150 into the middle floor 160. Other transmitters in comparison may have wireless signals that are relatively contained to their installation floor or level. For example transmitter 110 may not have wireless signals that extend past the middle floor 160 and transmitter 115 may not have wireless signals that extend past the ground floor 165.

Mobile devices receiving the signals from multi-level broadcast transmitters (e.g., transmitter 105) may interpret the signals originating from the physically installed location (e.g., a floor or level within an indoor environment) as being transmitted from an entirely different level. Accordingly, physical placement of a transmitter in a location is a factor in determining whether the transmitter is classified as being compatible or optimized for one or more positioning classifications or usage types. For example, a transmitter in an open area including multiple floors (e.g., transmitter 105) may be classified for horizontal positioning but not for vertical positioning. Alternatively, a transmitter with signals isolated to a particular floor or level (e.g., transmitter 115) may be classified for use in vertical positioning.

Transmitter classification may be determined by positioning server 125, the transmitter itself, may be assigned to the respective transmitter by a site administrator, or may be determined through crowdsourcing from user data collected in a location. For example, a positioning server can calculate the usage type or classification of transmitters according to predetermined line of site measurements within a location (e.g., indicated within a map). The positioning server may automatically calculate usage type with a 3D RF simulation when a building's 3D or 2.5D map and a transmitter's 3D coordinates are available. The positioning server may also calculate usage type from a 2D map with assumptions about the height of each floor. For example, the positioning server may utilize standardized height data for similar buildings/locations.

In some embodiments, a positioning server may utilize crowdsourcing to gather missing data regarding an existing partial map or to create a map without any predetermined input. Known propagation characteristics may be leveraged to determine which transmitters are likely to have signals that extend beyond their installed floor, or level. Proximity, and angle to particular openings such as stairs may be calculated and transmitters within a particular threshold may be unfit for vertical positioning assistance.

In other embodiments, classification for usage type is determined according to recorded measurements from each transmitter taken at various locations within the venue (e.g., by a surveyor). The classifications may be sent to a positioning sensor or to individual transmitters in a location.

In one embodiment, transmitters broadcast the type or classification of positioning that the transmitter is compatible with providing. For example, a transmitter, depending on the particular physical installation location within the indoor environment, may broadcast a classification (e.g., flag or status) identifying the transmitter as recommended/compatible for vertical and/or horizontal positioning assistance.

In one embodiment, transmitter classification or usage types may be implemented as a 2-bit field within a broadcast signal of a transmitter. The 2-bit field may describe four distinct usage types. For example, usage type 0 may indicate the transmitter is appropriate for vertical (e.g., floor determination) and horizontal (e.g., location within a floor, level, or altitude range) positioning. Some transmitters may be excluded from one or all types of positioning assistance for factors other than physical placement of the transmitter with respect to the location. Type 1, 2, and 3 classifications with the 2-bit field are examples or partial or complete exclusion types.

Positioning server 125 may exclude a transmitter from positioning assistance when a particular transmitter is one of many alternate (e.g., superfluous) transmitters within an area. In some embodiments, positioning server 125 may exclude a transmitter having high error rates. For example, positioning server 125 can determine a particular transmitter is prone to errors in providing one or more aspects of positioning assistance. To reduce the number of similarly situated transmitters to scan, positioning server 125 can adjust classifications for transmitters in a location. For example, positioning server 125 may not classify some of the transmitters within a same general location for use in positioning assistance by tagging the transmitters as incompatible, inaccessible, or in some way excluded from positioning. For example, a wireless access point may be configured exclusively for user data connectivity, or Internet access.

In one embodiment, type 1 2-bit classifications indicate a transmitter appropriate for horizontal positioning but not for vertical positioning. For example, the transmitter may be located in an open area exposed to two or more floors. In one embodiment, type 2 2-bit classifications indicate the transmitter is appropriate for vertical or floor determination, but not appropriate for horizontal positioning. For example, the transmitter may be part of a set of transmitters at the indoor environment and one or more of the transmitters may be bypassed in order to provide optimized assistance data.

In some cases, transmitters may be classified as unsuitable or not recommended for use with either type of positioning assistance. For example, a type 3 2-bit classification indicates the transmitter is not appropriate or recommended to provide positioning assistance in either the vertical or horizontal position. In other embodiments, other type classifications, and different or additional combinations or arrangements may be possible.

In one embodiment, mobile device 140 interfaces with a positioning server (e.g., positioning server 125) and a map server (e.g., map server 135). In some embodiments, mobile device 140 may retrieve map data directly from map server 135. In one embodiment, positioning server 125 receives map data (e.g., location 100 layout information) from map server 135, and generates assistance data for the mobile device 140. In one embodiment, assistance data is the data relevant to inferring or determining position or location of a device. Positioning server 125 and map server 135 are illustrated in FIG. 1 as being in close proximity to location 100, however in some embodiments, the positioning server 125 and map server 135 are located in a remote location away from location 100. In some embodiments, a single server may perform features or functionality described herein.

Positioning server 125 can receive and process requests for positioning assistance from mobile device 140 and provide assistance data. In response to a request for horizontal positioning, positioning server 125 may provide assistance data that includes transmitter identifiers (e.g., MAC addresses), usage types, transmitter positions, and heatmaps (e.g., RSSI and RTT data for each transmitter) for transmitters classified with the horizontal positioning assistance usage type. In response to a request for vertical positioning, positioning server 125 may provide assistance data that includes transmitter identifiers (e.g., MAC addresses), usage types, and transmitter positions, for transmitters classified with the vertical positioning assistance usage type.

Positioning server 125 can provide optimized assistance data according to the type positioning requested by the mobile device 140. For example, mobile device 140 requesting vertical positioning may receive assistance data omitting data associated with horizontal positioning transmitters. Therefore, assistance data provided to requesting mobile devices is compact and narrowly tailored to the particular type of positioning request (e.g., vertical or horizontal positioning) within the unique indoor environment.

In one embodiment, if a transmitter is detectable from multiple floors, positioning server 125 generates and sends heatmaps per floor for the detectable transmitter. For example, if transmitter 120 installed on ground floor 165 is detectable on top floor 155 and middle floor 160 (e.g., because of close proximity to open stairwell 150 or other physical feature of location 100), positioning server 125 can send specialized/individualized heatmaps, where each specialized heatmap is associated with one of top floor 155, middle floor 160, or ground floor 165. Each transmitter's respective heatmap for a floor may include data measurements for that floor associated with the transmitter. In one embodiment, positioning server 125 provides floor-based heatmaps for a transmitter when the respective transmitter has significant coverage for the floor (e.g., a coverage area greater than −90 dBm for a 100 square meter area, or other predetermined threshold).

Assistance data may further include Location Context Identifiers (LCI) or other data related to a physical location, such as a map of the location (e.g., including building or floor layout and points of interest), number of known access points, historical data traffic, or device activity associated with the position or location. Assistance data may be subdivided into multiple sub-locations (e.g., building, floor or level) such that a user or device can download or access the section of assistance data relevant to a current location. As the user or device moves from one location to another, the assistance related to the current location may be accessed locally or downloaded from a server. In other embodiments, the server may automatically determine related assistance that a device may need based on direction of movement or position of the device.

In one embodiment, the assistance data provided may include a limited subset of all potentially available transmitters. For example, mobile device 140 may request the positioning server exclude (e.g., from inclusion in the assistance data) transmitters classified as incompatible with horizontal and/or vertical positioning. In some embodiments, the positioning server, in response to a vertical positioning request may not include transmitters classified for only horizontal positioning (e.g. heatmaps may not be included for assistance data related to vertical positioning). In one embodiment, when providing assistance data for vertical positioning, RSSI and/or RTT measurement data for points within a map (e.g., heatmap) may be excluded as unnecessary. Therefore, for vertical and horizontal positioning assistance data excessive data transfers with superfluous information can be avoided.

In one embodiment, mobile device 140 requests positioning assistance data from positioning server 125 or scans the one or more transmitters (e.g., transmitters 105-120) for positioning assistance. In some embodiments, the transmitter(s) 105-120 provide the above described assistance data to mobile devices. For example, the transmitter may provide one or more of map information, location of the transmitter (e.g., x, y, and z coordinates on a venue map), and positioning classification or usage type (e.g., a 2-bit descriptor indicating vertical or horizontal position recommendation or compatibility).

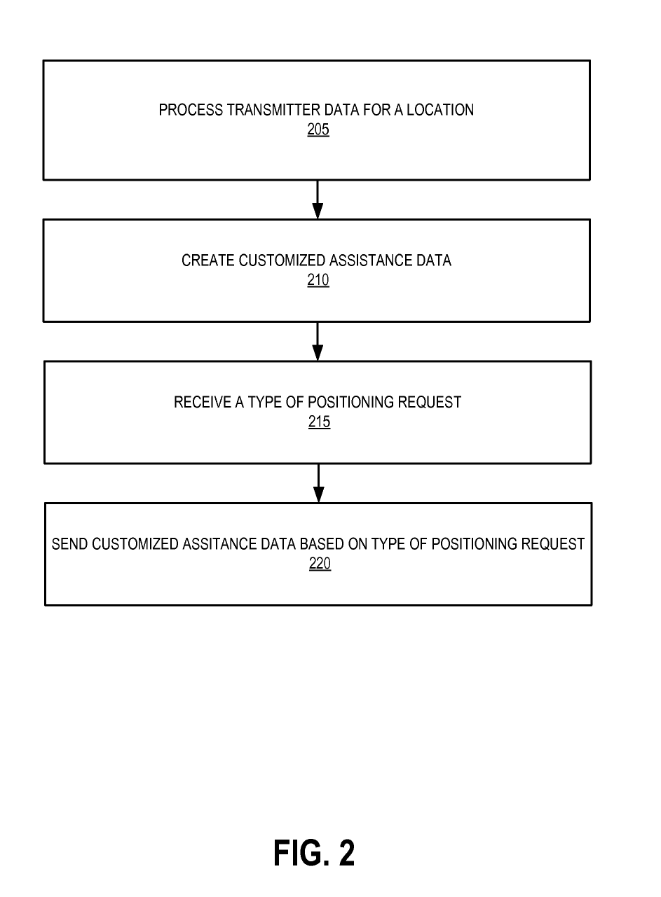

FIG. 2 is a flow diagram illustrating a method for a server to provide positioning assistance, in one embodiment. At block 205, transmitter data for a location is processed. For example, a positioning server (e.g., positioning server 125) may retrieve a list of transmitters in a location (e.g., location 100) and/or data parameters or measurements useful in assisting with positioning of devices within the location (e.g., a heatmap).

A positioning server may determine which transmitters within a location are classified as compatible for vertical positioning assistance, horizontal positioning assistance, both, or neither (e.g., incompatible with positioning assistance). In some embodiments, a positioning server provides the classification to each respective transmitter (e.g., transmitters 105-120 at location 100). In other embodiments, the transmitters may calculate their respective classification, or an on site administrator or other process may update the transmitter with a classification. In some embodiments, a positioning server requests transmitters to broadcast their classification. For example, the transmitter may be an AP, and the AP can provide the classification in outgoing communication to a positioning server. A positioning server can receive transmitter classification directly from the transmitters or may have access to the classification calculated at the positioning server.

In some embodiments, the positioning server may filter one excess or error prone transmitters from a list or dataset of transmitters to provide positioning assistance. For example, a cluster of close proximity transmitters may be filtered down such that one or more transmitters are not providing positioning assistance. In some embodiments, error reporting from users at the location is leveraged for determining which transmitters should be excluded from positioning assistance.

At block 210, customized assistance data sets are created. For example, a positioning server can create an assistance data set associated with transmitters classified for vertical positioning, and a separate assistance data set associated with transmitters classified for horizontal positioning. In some embodiments, a positioning server can create an assistance data set for transmitters capable of providing both vertical and horizontal positioning assistance.

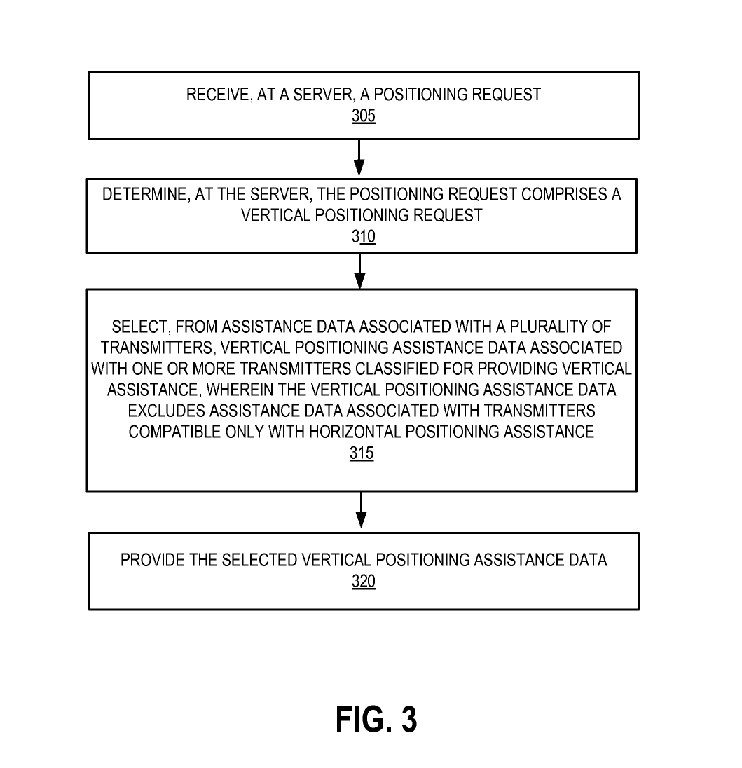

At block 215, customized assistance data is sent in response to receiving a respective type of positioning request. For example, in response to a request for vertical positioning assistance initiated by a mobile device (e.g., mobile device 140), a positioning server may send vertical positioning assistance data. In some embodiments, the vertical positioning assistance data is sent without horizontal positioning assistance data or other data associated with transmitters incompatible with providing vertical positioning assistance. Therefore, assistance data sent to devices or transmitters may be reduced in size compared to assistance data that is generic for all types of positioning requests (e.g., vertical and horizontal positioning requests). Further details of server based vertical position assistance are described below with respect to FIG. 3.

FIG. 3 is a flow diagram illustrating a method for a server to provide vertical positioning assistance data, in one embodiment. At block 305, a positioning request is received. For example, a mobile device or application server may send the request for positioning a mobile device within the indoor environment. An application server as used herein provides location based services on behalf of a venue (e.g., the indoor environment).

At block 310, the positioning request is determined to comprise a vertical positioning request. In some embodiments, the mobile device or positioning server issuing the request may specify the request is a request for vertical positioning. A vertical positioning request may precede a horizontal positioning request. For example, assistance data may be segmented by level or floor in order to limit a file transfer size sent to mobile devices. Before attempting horizontal positioning in an unknown environment, vertical positioning can determine which floor or level of assistance data should be sent to the requesting mobile device. Therefore, the mobile device, in response to determining a vertical position (e.g., floor or level) can receive assistance data relevant to the current floor, without excess data regarding other irrelevant floors. Reducing the transfer size of assistance data creates efficiencies at the mobile device as well as reduces the output load of a positioning server sending assistance data.

At block 315, vertical positioning assistance data associated with one or more transmitters classified for providing vertical assistance is selected, from assistance data associated with a plurality of transmitters. The vertical positioning assistance data may comprise data associated with transmitters compatible with vertical positioning assistance while excluding assistance data associated with transmitters compatible only with horizontal positioning assistance. Transmitters classified for providing vertical assistance may be installed in a location that isolates the wireless broadcast to the floor or level of the installed location. Therefore, mobile devices detecting signals from transmitters classified for vertical assistance may have a high confidence that the mobile devices are located within the same floor or level as the transmitter.

At block 320, the selected vertical positioning assistance data is provided. For example, the server may send the assistance data to the requesting mobile device or application server.

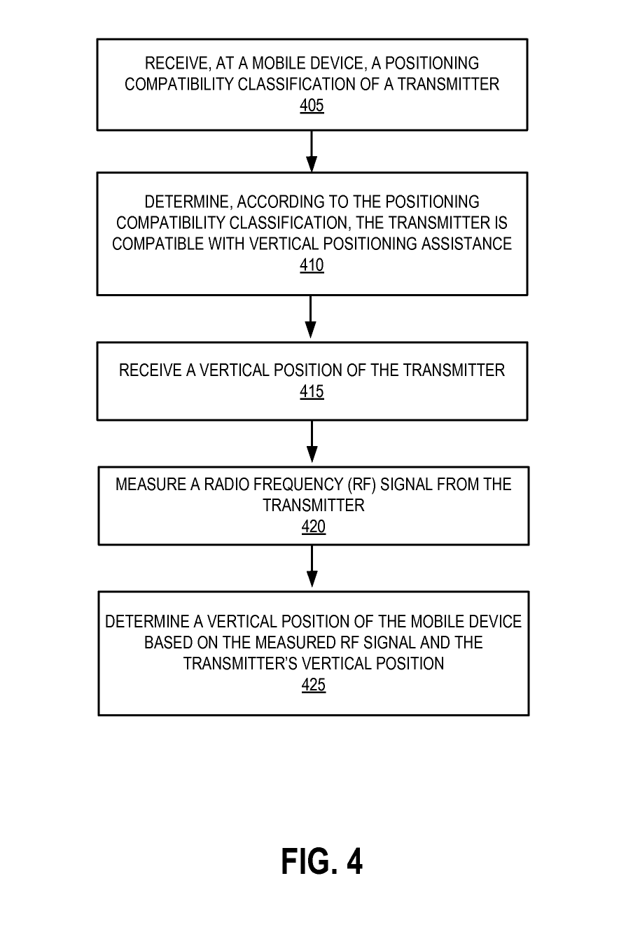

FIG. 4 is a flow diagram illustrating a method for a mobile device to perform vertical positioning, in one embodiment. At block 405, a positioning compatibility classification of a transmitter (e.g., a Bluetooth device, Wi-Fi access point, or a combination thereof) is received, at a mobile device. For example, a mobile device (e.g., mobile device 140) may receive the classification from a positioning server (e.g., positioning server 125) in response to a request for positioning, or directly from RF signals broadcast by nearby transmitters (e.g., transmitters 105-120). In some embodiments, a mobile device may attempt to discover nearby transmitters to initiate mobile based positioning and discover transmitters with positioning assistance compatibility classifications.

In some embodiments, RF signals from vertical positioning assistance compatible transmitters are isolated to within the respective transmitter's respective vertical position. For example, an AP may be physically installed in a location on a floor such that the AP is not visible to mobile devices on other floors.

A mobile device may actively or passively scan for nearby transmitters when performing mobile device positioning within a location (e.g., transmitters within detectable range of the mobile device within an indoor environment). The mobile device may read classifications within the broadcast signals received from the transmitters. The classification status of the transmitter may be a 2-bit code as described previously. The status or code may represent a vertical positioning assistance compatibility status, wherein vertical positioning comprises determining one or more of: an altitude, floor, level, or any combination thereof. The status or code may represent a horizontal positioning assistance compatibility status, wherein horizontal positioning comprises determining a position within one or more of: an altitude range, floor, or level. The status or code may represent a vertical and horizontal positioning assistance compatibility status, or an incompatibility for positioning assistance status. In some embodiments other combinations or types of status/classification are possible.

RF signals from transmitters may include additional data beyond classification and/or transmitter identification data. Additional data may be included in the same RF signal carrying the classification or may broadcast in separate independent signals. RF signals may include expected positioning accuracy associated with the transmitter (e.g., horizontal distance, vertical distance, or accuracy within a number of floors/levels). For example, positioning accuracy for a transmitter may be one or more of: horizontal: ˜30 m, vertical: ˜1 m, or floors/levels +/−0. Another example of position accuracy values may include one or more of: horizontal: ˜10 m, vertical: ˜10 m or floors/levels +/−3. Other representations of positioning accuracy are possible. RF signals may include a neighboring transmitter list. The neighboring transmitter list may be organized by positioning classification. For example, a neighboring transmitter list may suggest using nearby AP #1, AP #5 for vertical positioning and using nearby AP #2, AP #3, AP #4 for horizontal positioning. RF signals may include transmitter transmit power. RF signals may include a transmitter turn-around calibration factor (TCF). TCF is the additional time delay by a transmitter during RTT measurement.

In some embodiments a mobile device targets specific transmitter(s) for use in positioning according to classification. For example, in response to detecting RF signals from two different transmitters classified for vertical positioning located on different floors or levels, the mobile device selects the vertical position from the transmitter with the strongest RSSI (or other measurement characteristic) as the vertical position of the mobile device. For example, a mobile device requesting vertical positioning assistance can target transmitters classified (e.g., compatible) with providing vertical positioning assistance.

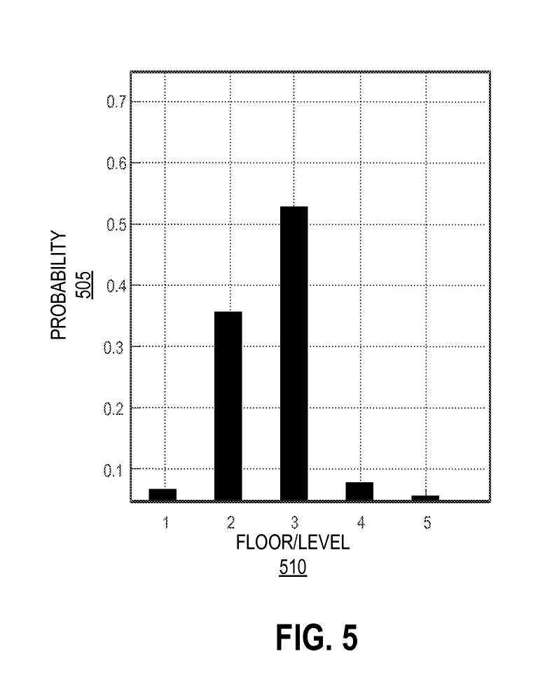

In other embodiments, in response to detecting RF signals from multiple different transmitters classified for vertical positioning located on different floors or levels, the mobile device analyzes available data to determine which transmitter is likely to represent the actual vertical position. The mobile device can output the estimated vertical position of the mobile device along with an associated uncertainty value. The uncertainty may represent a distance or number of floors/levels, or alternatively the uncertainty value may represent a confidence (e.g., percentage) in the output virtual positioning result. The mobile device may select, from a group or set of nearby transmitters, the vertical position associated with the transmitter most likely to represent the actual vertical position of the mobile device. Further details of vertical position selection from transmitters is described below with reference to FIG. 5.

At block 410, the transmitter is determined as compatible with vertical positioning assistance according to the positioning compatibility classification. In some embodiments, a mobile device requesting vertical positioning assistance ignores or bypasses transmitters that broadcast classifications different from the current positioning goal. For example, a mobile device may first request vertical positioning when in a new location, and then when the vertical positioning is determined, horizontal positioning is initiated. To focus on the relevant transmitters for the particular type of positioning for that moment, the mobile device may ignore transmitters that are irrelevant (e.g., not compatible, or of a different classification). When requesting vertical positioning, the mobile device may ignore transmitters setup for only horizontal positioning assistance, and transmitters that are not setup for or do not provide any type of positioning assistance. Bypassing consideration of ambiguously situated transmitters can enable more accurate floor determination than techniques that consider strength of all nearby transmitters (e.g., including transmitters that are in areas where their signal propagates through multiple floors). In one embodiment, to provide optimized positioning, s mobile device focuses scans on transmitters with a usage type or classification optimized for a particular type of positioning while ignoring unhelpful or potentially misleading transmitters.

At block 415, the transmitter's vertical position is received. The vertical position of the transmitter may be geographically referenced points or coordinates, which may be translated or interpreted as a floor or level within an indoor environment. Alternatively the mobile device may receive the transmitter's vertical position already in the form of an altitude range, floor, or level. The transmitter may broadcast its own vertical position or a server may provide the mobile device with the location of one or more transmitters in a location (e.g., via a map).

At block 420, a radio frequency (RF) signal from the transmitter is measured. For example, the mobile device can measure received signal strength indication (RSSI), round trip time (RTT), time distance of arrival (TDOA), time of arrival (TOA), or other RF signal characteristics. The RF signal may be the same or different from the signal containing the positioning compatibility classification of the transmitter.

At block 425, the mobile device's vertical position is determined according to the measured RF signal and the vertical position of the transmitter. In some embodiments, a mobile device determines a strong signal from a nearby transmitter indicates the transmitter is on the same relative floor or level. In one embodiment, the mobile device can determine its position is within the same vertical position as the transmitter when the measurements from 420 are within a threshold range. For example, if the transmitter RSSI is less than a predetermined threshold value, the mobile device may be considered as being in the same vertical position as the transmitter, and when the RSSI is above a predetermined threshold value, the mobile device may be at a different vertical position than the transmitter. In one embodiment, the mobile device can process the RF signal characteristics from block 420 to determine a range estimate from transmitter to the mobile device. The mobile device may refer to range estimates to determine whether its position should be considered within a same vertical position as the transmitter. For example, the mobile device may determine that its position is within 10 feet from the transmitter “A” on level 1 is also on level 1. The mobile device may refer to a map of the transmitters to determine the thresholds for measurements or range that determine whether a mobile device is within the same vertical position. Each transmitter within an indoor environment may have different power settings or physical placement that can change the determination of measurements and range for mobile devices to be considered as within the same vertical position. For example, a transmitter located close to a stairwell may have RF signals that can travel farther than other transmitters.

FIG. 5 is graph illustrating example probability results for determining vertical positioning, in one embodiment. In response to measuring RF signal characteristics (e.g., RSSI) from a group of transmitters (e.g., transmitters 105-120), a positioning server (e.g., positioning server 125) or a mobile device (e.g., mobile device 140) determines the probability that each respective transmitter represents the current mobile device vertical position. A positioning server or a mobile device can select the most probable transmitter (and associated vertical position) from the group of transmitters. In some embodiment, a positioning server or a mobile device can also check for alternate candidates within a certain probability threshold (e.g., within 0.2 from main peak or selected transmitter). For example, as illustrated in FIG. 5, combined probability for floor 3 is 0.52, floor 2 is 0.35, floor 4 is 0.09, floor 1 is 0.03, and floor 5 is 0.01. A positioning server or a mobile device can determine the main peak is floor 3 while floor 2 is an alternate (2^{nd}) eligible peak because floor 2 is within 0.2 (configurable threshold) from floor 3 (e.g., 0.52-0.35<0.2). As illustrated in FIG. 5, if the probability threshold is set as 0.2, positioning server 125 or mobile device 140 can ignore floors outside of the threshold (e.g., floors 1, 4, and 5). Therefore, in one embodiment floor 3 is output as the likely estimated floor of the mobile device, with the floor 2 as the alternative floor estimation (e.g., main peak=floor 3, 2^{nd} peak=floor 2, std=0.7746). Positioning server 125 or mobile device 140 may initially attempt horizontal positioning with floor 3 assistance data. However, if floor 3 assistance data generates large horizontal positioning uncertainty, a positioning server or a mobile device can switch to using floor 2 assistance data. If floor 2 also generates large horizontal positioning uncertainty a positioning server or a mobile device can try the remaining candidate floors in the order of vertical probability. In some embodiments, if one or more floors generate large horizontal positioning uncertainty, a positioning server or a mobile device can re-initialize and retry vertical positioning with updated RF signal measurements instead of or in addition to traversing the assistance data for the next probable floors.

The process of selecting the transmitter may be a function of the number of transmitters classified for vertical positioning assistance and each respective transmitter's RSSI (or other RF signal measurement characteristic). For each transmitter measurement, a positioning server or a mobile device can construct a floor estimation probability distribution function (PDF) or histogram, in consideration of RSSI. A positioning server or a mobile device can generate a PDF based on a typical RF propagation model or based on actual RF propagation within the particular indoor environment. For example, if RSSI>−40 dBm, then Pr(floor 3)=1.0, else if RSSI>−60 dBm, then Pr(floor 3)=0.8, Pr(floor 2)=0.1, Pr(floor 4)=0.1, else if RSSI>−80 dBm, then Pr(floor 3)=0.5, Pr(floor 2)=0.3, Pr(floor 4)=0.2. Positioning server 125 or mobile device 140 can combine PDFs to a single PDF such as Pr_{combined} (floor k)=Σᵢ₌₁^{x}(Prᵢ(floor k))(wᵢ) where x is the total number of transmitters, and w is the weight, where the weight may simply be represented as

$$\frac{1}{x}$$

or inversely proportional to RSSI (i.e., higher weighting to higher RSSI).

From the combined PDF, a positioning server or a mobile device can calculate the main peak and standard deviation, where the main peak may be the argument of the maximum (Pr_{combined}) and the standard deviation may be

$$\sqrt{\sum {Pr}_{combined} ( j ) \times {( floor \# ( j ) - floor \# ( main peak ) )}^{2}}$$

where j is the list of floors.

A positioning server or a mobile device can inflate the uncertainty projection (std) according to number of transmitters or number of measurements. For example, for 5 or more transmitters, no inflation, for 1-4 transmitters, std_{inflated}=std×(6−x).

In one embodiment, if std_{inflated} (e.g., uncertainty) is larger than a threshold (e.g., +/−3 floors/levels), then a positioning server or a mobile device recollects new/updated RF signal measurements. Alternatively or additionally, a positioning server or a mobile device can request data from other sensors in the mobile device to assist in determining vertical position.

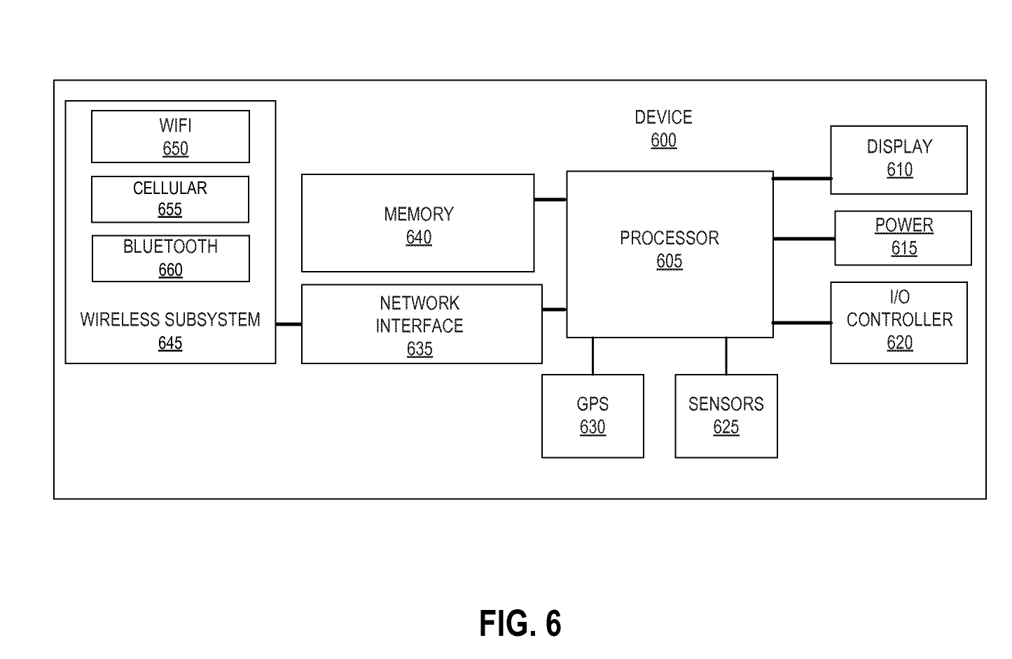

FIG. 6 is block diagram illustrating a device to perform mobile positioning, in one embodiment. In some embodiments, device 600 may be a server (e.g., positioning server 125 or map server 135), or a mobile device (e.g., mobile device 140). Device 600 may include one or more processors (e.g., a general purpose processor, specialized processor, or digital signal processor), a memory 640, I/O controller 620, and network interface 635. Device 600 may also include a number of device sensors coupled to one or more buses or signal lines further coupled to the processor(s) 605. It should be appreciated that device 600 may also include a display 610, a user interface (e.g., keyboard, touch-screen, or similar devices), a power device 615 (e.g., a battery), as well as other components typically associated with electronic devices. In some embodiments, device 600 may be a mobile or non-mobile device.

The device (e.g., device 600) can include one or more sensors 625. Sensors may include a clock, ambient light sensor (ALS), accelerometer, gyroscope, magnetometer, temperature sensor, barometric pressure sensor, red-green-blue (RGB) color sensor, ultra-violet (UV) sensor, UV-A sensor, UV-B sensor, compass, proximity sensor, and/or near field communication (NFC). The device may also include a Global Positioning Sensor (GPS) 630. In some embodiments, multiple cameras are integrated or accessible to the device.

Memory 640 may be coupled to processor 605 to store instructions (e.g., instructions to perform one or more embodiments as described herein) for execution by processor 605. In some embodiments, memory 640 is non-transitory. Memory 640 may also store one or more models or modules to implement embodiments described below. Thus, the memory 640 is a processor-readable memory and/or a computer-readable memory that stores software code (programming code, instructions, etc.) configured to cause the processor 605 to perform the functions described herein. Alternatively, one or more functions of the embodiments described herein may be performed in whole or in part in device hardware. In some embodiments, functionality described herein can be implemented as a module separate from other elements in the device 600.

Network interface 635 may also be coupled to a number of wireless subsystems 645 (e.g., Bluetooth 660, Wi-Fi 650, Cellular 655, or other networks) to transmit and receive data streams through a wireless link to/from a wireless network, or may be a wired interface for direct connection to networks (e.g., the Internet, Ethernet, or other wireless systems). The mobile device may include one or more local area network transceivers connected to one or more antennas. The local area network transceiver comprises suitable devices, hardware, and/or software for communicating with and/or detecting signals to/from wireless access points, and/or directly with other wireless devices within a network. In one aspect, the local area network transceiver may comprise a Wi-Fi communication system suitable for communicating with one or more wireless access points.

The device 600 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise other types of cellular telephony network or femtocells, such as, for example, TDMA, LTE, Advanced LTE, WCDMA, UMTS, 4G, or GSM. Additionally, any other type of wireless networking technologies may be used, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT). Using AFLT, a server may compute its position from phase measurements of pilot signals transmitted from a plurality of base stations.

The device as used herein (e.g., device 600) may be a: mobile device (e.g., mobile device 140), wireless device, cell phone, personal digital assistant, mobile computer, wearable device (e.g., watch, head mounted display, virtual reality glasses, etc.), tablet, personal computer, laptop computer, server (e.g., positioning server 125, map server 135, or other server), or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 600 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 600. Also, “mobile device” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above can also be considered a “mobile device” as used herein. Other uses may also be possible. While various examples given in the description below relate to mobile devices, the techniques described herein can be applied to any device for which accurate context inference is desirable.

The device may communicate wirelessly with a plurality of wireless access points using RF signals (e.g., 2.4 GHz, 3.6 GHz, and 4.9/5.0 GHz bands) and standardized protocols for the modulation of the RF signals and the exchanging of information packets. For example, the protocol may be Institute of Electrical and Electronics Engineers (I3) 802.11x (e.g., 802.11n, 802.11ac, 802.11ax, etc.). By extracting different types of information from the exchanged signals, and utilizing the layout of the network (i.e., the network geometry) the mobile device may determine position within a predefined reference coordinate system.

It should be appreciated that embodiments of the invention as will be hereinafter described may be implemented through the execution of instructions, for example as stored in the memory 640 or other element, by processor 605 of device and/or other circuitry of device and/or other devices. Particularly, circuitry of device, including but not limited to processor 605, may operate under the control of a program, routine, or the execution of instructions to execute methods or processes in accordance with embodiments of the invention. For example, such a program may be implemented in firmware or software (e.g. stored in memory 640 and/or other locations) and may be implemented by processors, such as processor 605, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Some or all of the functions, engines or modules described herein (e.g., as performed by mobile device 140 or positioning server 125) may be performed by the device itself and/or some or all of the functions, engines or modules described herein may be performed by another system connected through I/O controller 620 or network interface 635 (wirelessly or wired) to the device. Thus, some and/or all of the functions may be performed by another system and the results or intermediate calculations may be transferred back to the device. In some embodiments, such other device may comprise a server configured to process information in real time or near real time. In some embodiments, the other device is configured to predetermine the results, for example based on a known configuration of the device. Further, one or more of the elements illustrated in FIG. 6 may be omitted from the device.

The server may optionally store auxiliary position/motion data in memory that may be derived from information received from various sources at the device 600 as described below. Moreover, in other embodiments, supplemental information may include, but not be limited to, information that can be derived or based upon Bluetooth signals, transmitters, RFID tags, and/or information derived from a map (e.g., receiving coordinates from a digital representation of a geographical map by, for example, a user interacting with a digital map).

Embodiments described herein may be implemented as software, firmware, hardware, module, or engine. In one embodiment, the previous description may be implemented by one or more general purpose processors (e.g., processor 605) and in memory (e.g., device memory 640) to achieve the previously desired functions (e.g., the methods of FIGS. 2, 3, and 4).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions or modules described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for performing positioning, the method comprising:
receiving, at a mobile device, a positioning compatibility classification of a first transmitter;
determining, according to the positioning compatibility classification, the first transmitter is compatible with vertical positioning assistance;
receiving a vertical position of the first transmitter;
measuring a first radio frequency (RF) signal from the first transmitter; and
determining a vertical position of the mobile device based on the first measured RF signal and the first transmitter's vertical position.

2. The method of claim 1, wherein the positioning compatibility classification comprises one or more of:
a vertical positioning assistance compatibility status, wherein vertical positioning comprises determining one or more of: an altitude, floor, or level,
a horizontal positioning assistance compatibility status, wherein horizontal positioning comprises determining a position within one or more of: an altitude range, floor, or level,
a vertical and horizontal positioning assistance compatibility status,
an incompatibility for positioning assistance status, or
any combination thereof.

3. The method of claim 1, wherein the first transmitter is one or more of a Bluetooth device, Wi-Fi access point, or any combination thereof.

4. The method of claim 1, further comprising:
determining, according to a positioning compatibility classification received from a second transmitter, the second transmitter is compatible with vertical positioning assistance;
determining the vertical position of the second transmitter is different than the vertical position of the first transmitter;
measuring a second RF signal from the second transmitter;
analyzing the first measured RF signal and the second measured RF signal together; and
determining, in response to analyzing the first measured RF signal and the second measured RF signal, the vertical position of the first transmitter is more likely to represent the vertical position of the mobile device than the vertical position of the second transmitter.

5. The method of claim 1, further comprising:
receiving, at the mobile device, a positioning compatibility classification of a second transmitter;
determining, according to the positioning compatibility classification of the second transmitter, the second transmitter is compatible with horizontal positioning assistance;
receiving a horizontal position of the second transmitter;
measuring a second RF signal from the second transmitter; and
determining a horizontal position of the mobile device according to:
the second measured RF signal,
the vertical position of the mobile device, and
the horizontal position of the second transmitter.

6. The method of claim 1, wherein the positioning compatibility classification is received from a server or the first transmitter.

7. A mobile device comprising:
a processor; and
a storage device coupled to the processor and configurable for storing instructions, wherein the processor configured to:
receive a positioning compatibility classification of a first transmitter;
determine, according to the positioning compatibility classification, the first transmitter is compatible with vertical positioning assistance;
receive a vertical position of the first transmitter;
measure a first radio frequency (RF) signal from the first transmitter; and
determine a vertical position of the mobile device based on the first measured RF signal and the first transmitter's vertical position.

8. The mobile device of claim 7, wherein the positioning compatibility classification comprises one or more of:
a vertical positioning assistance compatibility status, wherein vertical positioning comprises determining one or more of: an altitude, floor, level, or any combination thereof,
a horizontal positioning assistance compatibility status, wherein horizontal positioning comprises determining a position within one or more of: an altitude range, floor, level, or any combination thereof,
a vertical and horizontal positioning assistance compatibility status,
an incompatibility for positioning assistance status, or
any combination thereof.

9. The mobile device of claim 7, wherein the first transmitter is one or more of a Bluetooth device, Wi-Fi access point, or any combination thereof.

10. The mobile device of claim 7, further comprising instructions to:
determine, according to a positioning compatibility classification received from a second transmitter, the second transmitter is compatible with vertical positioning assistance;
determine the vertical position of the second transmitter is different than the vertical position of the first transmitter;
measure a second RF signal from the second transmitter;
analyze the first measured RF signal and the second measured RF signal together; and
determine, in response to analyzing the first measured RF signal and second measured RF signal, the vertical position of the first transmitter is more likely to represent the vertical position of the mobile device than the vertical position of the second transmitter.

11. The mobile device of claim 7, further comprising:
receive, at the mobile device, a positioning compatibility classification of a second transmitter;
determine, according to the positioning compatibility classification of the second transmitter, the second transmitter is compatible with horizontal positioning assistance;
receive a horizontal position of the second transmitter;
measure a second RF signal from the second transmitter; and
determine a horizontal position of the mobile device according to:
the second measured RF signal,
the vertical position of the mobile device, and
the horizontal position of the second transmitter.

12. The mobile device of claim 7, wherein the positioning compatibility classification is received from a server or the first transmitter.

13. A method for providing positioning assistance data at a server, the method comprising:
receiving, at the server, a first positioning request;
determining, at the server, the first positioning request comprises a vertical positioning request;
selecting, from assistance data associated with a plurality of transmitters, vertical positioning assistance data associated with one or more transmitters classified for providing vertical assistance, wherein the assistance data comprises vertical positioning assistance data, and wherein the vertical positioning assistance data comprises data associated with transmitters compatible with vertical positioning assistance while excluding assistance data associated with transmitters compatible only with horizontal positioning assistance; and
providing the selected vertical positioning assistance data.

14. The method of claim 13, wherein a vertical positioning request comprises a request for determining one or more of a mobile device's: altitude, floor, level, or any combination thereof.

15. The method of claim 13, wherein assistance data comprises:
location data,
identification data,
received signal strength indication (RSSI) measurement,
round trip time (RTT) measurement,
time distance of arrival (TDOA) measurement,
time of arrival (TOA) measurement, or
any combination thereof.

16. The method of claim 13, wherein the vertical assistance data further excludes assistance data associated with transmitters classified as incompatible or unavailable for positioning assistance.

17. The method of claim 13, further comprising:
receiving, at the server, a second positioning request;
determining, at the server, the second positioning request is a horizontal positioning request, wherein a horizontal positioning request comprises a request for determining one or more of a mobile device's position within: an altitude range, floor, level, or any combination thereof;
selecting, from the assistance data associated with the plurality of transmitters, horizontal positioning assistance data associated with one or more transmitters classified for providing horizontal assistance, wherein the assistance data comprises horizontal positioning assistance data, and wherein the horizontal assistance data comprises data associated with transmitters compatible with horizontal positioning assistance, while excluding assistance data associated with transmitters classified only for vertical positioning assistance; and
providing the selected horizontal positioning assistance data.

18. A server for providing mobile device positioning assistance, comprising:
a processor; and
a storage device coupled to the processor and configurable for storing instructions, wherein the processor configured to:
receive a first positioning request;
determine the first positioning request comprises a vertical positioning request;
select, from assistance data associated with a plurality of transmitters, vertical positioning assistance data associated with one or more transmitters classified for providing vertical assistance, wherein the assistance data comprises vertical positioning assistance data, and wherein the vertical positioning assistance data comprises data associated with transmitters compatible with vertical positioning assistance while excluding assistance data associated with transmitters compatible only with horizontal positioning assistance; and
provide the selected vertical positioning assistance data.

19. The server of claim 18, wherein a vertical positioning request comprises a request for determining one or more of a mobile device's: altitude, floor, level, or any combination thereof.

20. The server of claim 18, wherein assistance data comprises:
location data,
identification data,
received signal strength indication (RSSI) measurement,
round trip time (RTT) measurement,
time distance of arrival (TDOA) measurement,
time of arrival (TOA) measurement, or
any combination thereof.

21. The server of claim 18, wherein the vertical assistance data further excludes assistance data associated with transmitters classified as incompatible or unavailable for positioning assistance.

22. The server of claim 18, further comprising:
receive a second positioning request;
determine the second positioning request is a horizontal positioning request, wherein a horizontal positioning request comprises a request for determining one or more of a mobile device's position within: an altitude range, floor, level, or any combination thereof;
select, from the assistance data associated with the plurality of transmitters, horizontal positioning assistance data associated with one or more transmitters classified for providing horizontal assistance, wherein the assistance data comprises horizontal positioning assistance data, and wherein the horizontal assistance data comprises data associated with transmitters compatible with horizontal positioning assistance, while excluding assistance data associated with transmitters classified only for vertical positioning assistance; and
provide the selected horizontal positioning assistance data.
